(19) United States
(12) Patent Application Publication
(10) Pub. No.: US 2026/0161480 A1
(43) Pub. Date: Jun. 11, 2026

(54) PACKET MERGING

(71) Applicant: Arm Limited, Cambridge (GB)

(72) Inventors: Herath Mudiyanselage Isuru Prasenajith HERATH, Cambridge (GB); Karel Hubertus Gerardus WALTERS, Cambridge (GB); Michael James COX, Cambridge (GB); Isak Edo VIVANCOS, Cambridge (GB)

(21) Appl. No.: 18/975,110

(22) Filed: Dec. 10, 2024

(51) Int. Cl. G06F 9/52; H04L 69/14; H04L 69/22

(52) U.S. Cl. CPC G06F 9/524; H04L 69/14; H04L 69/22

(57) ABSTRACT

An apparatus includes offload circuitry to transmit to coprocessing circuitry an instruction packet comprising one or more instructions offloaded by processing circuitry for execution by the coprocessing circuitry; and packet merging circuitry to perform a packet merge. The packet merge includes determining whether the instruction packet has capacity to include one or more additional instructions offloaded by the processing circuitry for execution by the coprocessing circuitry; and including the one or more additional instructions in the instruction packet in response to determining that the instruction packet has capacity to include the one or more additional instructions.

### BACKGROUND

### Technical Field

The present technique relates to the field of data processing.

### Technical Background

Processing circuitry typically executes instructions. One or more instructions may be offloaded by processing circuitry and transmitted to coprocessing circuitry for execution by the coprocessing circuitry.

### SUMMARY

At least some examples of the present technique provide an apparatus comprising:
offload circuitry to transmit to coprocessing circuitry an instruction packet comprising one or more instructions offloaded by processing circuitry for execution by the coprocessing circuitry; and packet merging circuitry to perform a packet merge comprising: determining whether the instruction packet has capacity to include one or more additional instructions offloaded by the processing circuitry for execution by the coprocessing circuitry; and including the one or more additional instructions in the instruction packet in response to determining that the instruction packet has capacity to include the one or more additional instructions.

At least some examples of the present technique provide a system comprising: the apparatus described above and the coprocessing circuitry.

At least some examples of the present technique provide a system comprising: the apparatus described above, implemented in at least one packaged chip;
at least one system component; and
a board,

wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a non-transitory computer-readable medium storing computer-readable code for fabrication of the apparatus described above.

At least some examples of the present technique provide a method comprising:
transmitting to coprocessing circuitry an instruction packet comprising one or more instructions offloaded by processing circuitry for execution by the coprocessing circuitry; and
performing a packet merge comprising:
   determining whether the instruction packet has capacity to include one or more additional instructions offloaded by the processing circuitry for execution by the coprocessing circuitry; and
   including the one or more additional instructions in the instruction packet in response to determining that the instruction packet has capacity to include the one or more additional instructions.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example system of a processor and a coprocessor;

FIG. 2 illustrates an example arrangement of a main processor and a coprocessor to process instruction packets offloaded by the main processor;

FIG. 3 illustrates an example communication channel between a processor and a coprocessor;

FIG. 4 illustrates an example packet merge according to the present technique;

FIG. 5 shows steps for performing a packet merge in response to detecting a stall condition;

FIG. 6 shows an example arrangement for performing a packet merge;

FIG. 7A shows an example instruction sequence;

FIG. 7B shows an example pipeline for processing the instruction sequence of FIG. 7A at cycle N;

FIG. 7C shows an example pipeline for processing the instruction sequence of FIG. 7A at cycle N+1;

FIG. 7D shows an example pipeline for processing the instruction sequence of FIG. 7A at cycle N+2;

FIG. 7E shows an example pipeline for processing the instruction sequence of FIG. 7A at cycle N+3;

FIG. 8 shows an example of a missed packet merge opportunity;

FIG. 9 shows steps for triggering a packet merge in response to detecting a predicted future stall condition;

FIG. 10 shows steps for triggering a packet merge using a future stall tracking structure;

FIG. 11 shows an example future stall tracking structure;

FIG. 12 shows an example future stall tracking structure and an arrangement for updating entries of the future stall tracking structure;

FIG. 13 shows steps for packet merging based on predicting a future stall associated with the coprocessor and transmitting an instruction packet based on satisfaction of a transmit condition; and

FIG. 14 illustrates a system and a chip-containing product.

### DESCRIPTION OF EXAMPLES

An apparatus comprises offload circuitry to transmit to coprocessing circuitry an instruction packet comprising one or more instructions offloaded by processing circuitry for execution by the coprocessing circuitry.

In some implementations, a coprocessor is provided to perform dedicated processing and may be optimized and designed for that dedicated processing. Hence, by offloading instructions to coprocessing circuitry which is optimized for processing those offloaded instructions, overall processing performance can be improved.

The present inventors have identified that instruction packets offloaded to a coprocessor can be under-utilized, in that instruction packets may have capacity to include more instructions than they actually contain. For example, processing circuitry may determine whether instructions are intended for execution by the coprocessing circuitry, and then package these one or more instructions into an instruction packet for transmitting to the coprocessing circuitry. One way of doing this is to package the one or more instructions which have been received at the processing circuitry in the same processing cycle into an instruction packet and then transmit the instruction packet to the coprocessing circuitry.

However, this can result in instruction packets which are not full being sent to the coprocessing circuitry for execution. In some examples, an instruction packet may be a fixed size and able to include a predetermined number of instructions, such as four instructions, whereas in a given processing cycle, only one or two instructions are to be offloaded to coprocessing circuitry for execution. As a result, the instruction packet may include the one or two instructions but may also include a number of empty slots.

Hence, in the examples discussed below, the apparatus also includes packet merging circuitry to perform a packet merge. The packet merge comprises: determining whether the instruction packet has capacity to include one or more additional instructions offloaded by the processing circuitry for execution by the coprocessing circuitry; and including the one or more additional instructions in the instruction packet in response to determining that the instruction packet has capacity to include the one or more additional instructions.

It will be appreciated that the instruction packet to which the one or more additional instructions may be added may be an instruction packet that is already in a communication channel to the coprocessing circuitry (i.e. it has already been offloaded by the offload circuitry), or it may be an instruction packet for which offload to the coprocessing circuitry/communication channel has been delayed.

As a result, the likelihood that a stall at the coprocessing circuitry causes the processing circuitry to stall is reduced. This is because a stall associated with the coprocessing circuitry can cause the processing circuitry to also stall if the processing circuitry is waiting to offload an instruction to the coprocessing circuitry for execution by the coprocessing circuitry. The processing circuitry may be waiting to offload the instruction, which it cannot do due to the stall causing a back-up of instructions from the coprocessing circuitry to the processing circuitry, before the processing circuitry is able to execute a next instruction which is for execution by the processing circuitry. By performing the packet merge, an instruction for execution by the coprocessing circuitry can be included in an existing instruction packet (whether that is an instruction packet that has been delayed or that has already been offloaded but is now stuck due to the stall), and thus rather than having to wait for the coprocessor to exit the stall, the processing circuitry can carry on executing the next instruction in an instruction sequence. This reduces the likelihood that the processing circuitry will stall and removes processing bubbles at the processing circuitry. Hence, processing performance is increased.

Furthermore, the likelihood that partially filled instruction packets are transmitted to the coprocessing circuitry for execution is reduced. This increases instruction packet utilization, increases utilization of the bandwidth between the processor and coprocessor, and reduces the power incurred in sending packets to the coprocessor. As a result, power efficiency is increased.

In some examples, the one or more additional instructions are associated with a later processing cycle of the processing circuitry than the one or more instructions. For example, the one or more additional instructions may be received at or offloaded by the processing circuitry at a later processing cycle than the one or more instructions. Hence, the packet merge checks whether an instruction packet that has already been created and already includes one or more instructions has capacity to include additional instructions that are received at the processing circuitry at a later processing cycle than the one or more instructions already included in the packet. In this way, after a packet merge has been performed, the instruction packet can include instructions associated with different processing cycles, i.e. instructions which are received at the processing circuitry at different (such as subsequent) processing cycles.

In some examples, the packet merging circuitry is configured to perform the packet merge in response to detecting a stall condition associated with the coprocessing circuitry. Hence, the packet merge can selectively be performed to maximize instruction packet utilization and utilization of the bandwidth between the processor and coprocessor when the throughput is likely to be reduced. In examples where the instruction packet has yet to be offloaded to the coprocessing circuitry, by performing the packet merge in response to detection of the stall condition, the likelihood that delaying the transmission of an instruction packet to include additional instructions in the instruction packet having a negative impact on coprocessing processing efficiency is reduced. For example, it can be useful to perform packet merging, which can introduce a delay to the sending of the instruction packets to the coprocessor, when the coprocessor is already experiencing or likely to experience a stall. This can mitigate the delay introduced by a packet merge and increase instruction packet throughput to the coprocessing circuitry. In examples where the instruction packet has already been offloaded but not yet received by the coprocessor, by performing the packet merge in response to detection of the stall condition, utilization of the instruction packets already present on a communication channel to the coprocessor can be increased. This means that for the same number of instruction packets, more instructions are received at the coprocessor (when the coprocessor is no longer stalling). This increases power efficiency.

It will be appreciated that in some examples, when a stall condition is not detected, the packet merge may not be performed. Hence, throughput can be maximized when the stall condition is not detected to maximize the utilization of the coprocessor, and when the stall condition is detected, utilization of the bandwidth between the processor and coprocessor is maximized. This improves processing performance.

In some examples, the stall condition comprises one or more of a current stall condition indicative of a current stall associated with the coprocessing circuitry and a predicted future stall condition indicative of a predicted future stall associated with the coprocessing circuitry. The packet merge can therefore be performed for current or likely future stalls of the coprocessing circuitry to utilize spare capacity in instruction packets when the instructions in the instruction packets are unlikely to be executed without delay due to the current or future stall.

In some examples, to detect the current stall condition, the packet merging circuitry is configured to receive a signal indicating a loading of the coprocessing circuitry. For example, the coprocessing circuitry may signal the packet merging circuitry that the coprocessing circuitry has stalled or is likely to stall. In some examples, the signal indicates that an occupancy of a buffer associated with the coprocessing circuitry for incoming instruction packets has exceeded a predetermined threshold. Hence, the loading of the coprocessing circuitry can be efficiently signaled.

In some examples, to detect the predicted future stall condition, the packet merging circuitry is configured to determine that the coprocessing circuitry is likely to stall during future execution of one or more instructions offloaded by the processing circuitry. Thus, rather than waiting for a stall to already have started and for that to be signaled from the coprocessing circuitry, advanced warning of a stall occurring is supported. As a result, packet merging can be performed earlier than would have otherwise been possible and a delay between signaling a stall and performing the packet merging can be reduced. This increases utilization of the bandwidth between the processor and coprocessor by reducing the number of partially utilized packets and improves processing performance.

In some examples, the packet merging circuitry is configured to determine that the coprocessing circuitry is likely to stall based on determining information associated with the one or more instructions offloaded by the processing circuitry, the information being indicative of a likelihood that the one or more instructions offloaded by the processing circuitry will stall the coprocessing circuitry during future execution of the one or more instructions. Hence, an efficient determination of whether the coprocessing circuitry is likely to stall can be performed.

In some examples, to determine the information, the packet merging circuitry is configured to determine one or more of: an instruction type of the one or more instructions; a program counter and/or memory address associated with the one or more instructions; and data targeted by the one or more instructions. Thus, depending on implementation, an efficient determination of the coprocessing stall likelihood can be performed.

In some examples, the instruction type comprises a memory access instruction type and a non-memory access instruction type. For example, a given instruction may be more likely to cause the coprocessing circuitry to stall than another instruction. An example is a memory access (such as a memory load) instruction, which may cause a stall in the event of a cache miss, i.e. because data is then retrieved from the memory system rather than a cache, or from a lower level cache, thereby introducing a delay. Hence, the instruction type itself can be indicative of whether a stall is likely when the coprocessing circuitry comes to executing the instruction.

In some examples, the packet merging circuitry is configured to determine that the coprocessing circuitry is likely to stall based on a future stall tracking structure, the future stall tracking structure to store entries determined based on the information and indicative of respective likelihoods that the one or more instructions offloaded by the processing circuitry will stall the coprocessing circuitry during future execution of the one or more instructions. By referring to the tracking structure, the likelihood of whether an instruction will cause a stall (and thus that the packet merge is to be performed) can be efficiently determined. In some examples, the future stall tracking structure corresponds to a long latency instruction predictor configured to predict whether a given instruction for execution by the coprocessing circuitry is likely to stall the coprocessing circuitry when executed by the coprocessing circuitry.

The future stall tracking structure can take a variety of forms and the present technique is not particularly limited in this respect.

In some examples, the future stall tracking structure comprises a counter to track a likelihood of the coprocessing circuitry stalling during future instruction execution.

In some examples, the future stall tracking structure indicates a relative frequency of instructions in the one or more instructions offloaded by the processing circuitry having a given instruction type, and the packet merging circuitry is configured to determine that the coprocessing circuitry is likely to stall based on determining that the relative frequency exceeds a predetermined threshold. The relative frequency of instructions having a given type (i.e. being memory access instructions) in a window of instructions can be used to inform a likelihood of the coprocessing circuitry stalling. For example, if a relatively large number of memory load requests are offloaded in a window of time, the likelihood that a cache miss will occur at the coprocessing circuitry is increased and so the likelihood of a stall occurring is increased.

In some examples, the future stall tracking structure comprises a table indexed based on program counter values and/or memory addresses associated with the one or more instructions offloaded by the processing circuitry, and the packet merging circuitry is configured to determine that the coprocessing circuity is likely to stall based on determining that an entry in the table corresponding to a program counter and/or memory address associated with a given instruction offloaded by the processing circuitry indicates that the coprocessing circuitry is likely to stall during future execution of the given instruction. Hence, the stall likelihood information can be efficiently accessed and updated.

In some examples, the packet merging circuitry is configured to update the entries based on determining whether a given entry correctly predicted whether a given instruction offloaded by the processing circuitry stalled the coprocessing circuitry based on a completion response from the coprocessing circuitry. In this way, the accuracy of the entries can be maintained based on feedback from the coprocessing circuitry as to whether a given instruction actually caused a stall. This increases the likelihood that the instructions predicted to cause a stall (and thus which trigger the packet merge) are actually instructions that cause a stall. Hence, the likelihood that the packet merge is triggered when it would be beneficial (i.e. when a stall is likely to occur) is increased. This increases processing performance.

In some examples, in response to detecting the stall condition associated with the coprocessing circuitry, the packet merging circuitry is configured to repeat the packet merge for one or more subsequent processing cycles and delay transmitting the instruction packet to the coprocessing circuitry packet until a transmit condition is satisfied. Thus, selective offload of an instruction packet is supported. This can increase the likelihood that the instruction packet is full when transmitted to the coprocessing circuitry. This can also avoid the provision of circuitry to support performing a packet merge on instruction packets that have already been offloaded.

In some examples, the transmit condition comprises one or more of: determining that a predetermined amount of time has elapsed since the delay started; determining that the instruction packet has no capacity to include an additional instruction; and/or determining that a completion response has been received from the coprocessing circuitry indicating that an instruction likely to stall the coprocessing circuitry has been completed. Hence, the instruction packet may be transmitted when one or more of various conditions are satisfied, which may be chosen depending on implementation.

In some examples, to transmit the instruction packet to the coprocessing circuitry, the offload circuitry is configured to transmit the instruction packet to a communication channel to the coprocessing circuitry, and the packet merging circuitry is configured to perform the packet merge after the offload circuitry has transmitted the instruction packet to the communication channel. Hence, the packet merge may be performed after the instruction packet has been transmitted to the coprocessing circuitry and after it has entered the communication channel, but before the coprocessing circuitry has received the instruction packet. In this way, the communication channel itself may act as a buffer between the processing circuitry and the coprocessing circuitry, and the packet merge circuitry may be configured to add one or more additional instructions to one or more instruction packets in the communication channel in response to determining that the one or more instructions packets have capacity. The packet merging circuitry may perform the packet merge on the most recently offloaded instruction packet. In some examples, the packet merge circuitry may perform the packet merge on an instruction packet further from the processing circuitry than the most recently offloaded instruction packet. Thus, the packet merge circuitry may reach further into the communication channel to add additional instructions, thereby further increasing the utilization of the bandwidth of the communication channel, at the expense of a more complex arrangement.

In some examples, determining whether the instruction packet has capacity to include one or more additional instructions comprises comparing a quantity of the one or more additional instructions to a quantity of empty instruction slots in the instruction packet for receiving instructions. Hence, an efficient determination of capacity can be performed.

As referred to herein, an instruction packet capacity may correspond to the maximum number of instructions that can be sent to coprocessing circuitry in a single processing cycle. Hence, the capacity may vary depending on implementation. An empty slot in an instruction packet may correspond to a space in the instruction packet that is able to accommodate an instruction.

In some examples, the apparatus further comprises instruction packing circuitry to receive the one or more instructions offloaded by the processing circuitry and pack the one or more instructions into the instruction packet. This instruction packet may then be transmitted by the offload circuitry to the coprocessing circuitry for execution.

In some examples, the one or more instructions and the one or more additional instructions are from an instruction stream executed by the processing circuitry. Hence, instructions from an instruction stream executed by the processing circuitry (i.e. of a main processor) may be offloaded to coprocessing circuitry for execution by the coprocessing circuitry rather than the processing circuitry. In some implementations, a coprocessor is provided to perform dedicated processing and may be optimized and designed for that dedicated processing. Hence, by offloading instructions to coprocessing circuitry which is optimized for processing those offloaded instructions, overall processing performance can be improved.

In some examples, the apparatus comprises the processing circuitry, the processing circuitry comprising a processing pipeline, and in which the one or more instructions and the one or more additional instructions are offloaded from one or more execution units of the processing pipeline for offloading instructions for execution by the coprocessing circuitry. Thus, the instructions for offloading to coprocessing circuitry may be identified as such by the one or more execution units that offload them.

In some examples, the packet merging circuitry is configured to suppress a processing circuitry stall signal in response to including the one or more additional instructions in the instruction packet. In one approach, when the coprocessing circuitry detects a stall, the coprocessing circuitry generates and sends a stall signal to the processing circuitry to indicate the stall. This can result in the processing circuitry (i.e. the main processor) also stalling. However, by suppressing the stall signal as described, the stall can be prevented from causing the processing circuitry also from stalling. This reduces the number of bubbles (i.e. a processing cycle absent of instruction processing) in the processing circuitry, thereby increasing the efficiency of the processing while reducing the power waste incurred by sending partially filled instruction packets.

Particular examples will now be described with reference to the figures.

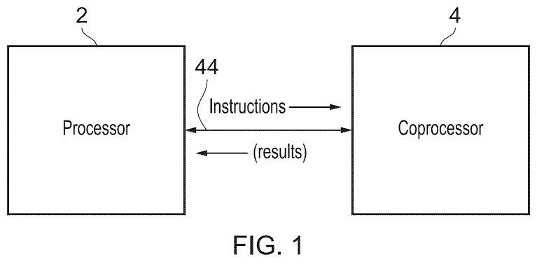

FIG. 1 shows an example system of a processor or CPU 2 connected to and/or associated with a coprocessor 4.

The processor 2 is configured to execute instructions, and can selectively offload instructions to coprocessor 4 for execution at the coprocessor 4. The instructions offloaded to the coprocessor 4 can be one or more of:
instructions which the processor is incapable of executing but which the coprocessor is capable of executing;
instructions which the processor could in principle execute but which the coprocessor is capable of executing more efficiently (for example, mathematical functions for which the coprocessor is particularly configured); and
instructions which both the processor and the coprocessor are capable of executing with similar efficiency, but which are passed to the coprocessor to relieve a processing load at the processor.

The processor 2 provides instructions to the coprocessor 4 by a communication channel 44. The results of execution of those instructions by the coprocessor 4 may be returned at least in part to the processor 2, for example by the communication channel 44. Alternatively, the instructions executed by the coprocessor 4 may be implemented directly by the coprocessor 4, for example by the coprocessor 4 moving data from one memory location to another, or by the coprocessor 4 performing a calculation and storing the result in a particular memory location. In these latter examples, the coprocessor 4 may simply perform the required function without further reference to the processor 2, or alternatively the coprocessor 4 may return an indication to the processor 2 that the required function has been performed.

In some examples, the processor 2 may be a scalar processor and the coprocessor 4 may be a vector and/or matrix processor. Here, vector or matrix processing operations involve applying a single processing instruction to data items of a data vector having a plurality of data items at respective positions in the data vector or to data items of a data matrix having a multi-dimensional array of data items. By contrast, scalar processing operates on, effectively, single data items

rather than on data vectors or matrices. Vector or matrix processing can be useful in instances where processing operations are carried out on many different instances of the data to be processed. In a vector or matrix processing arrangement, a single instruction can be applied to multiple data items at the same time. This can improve the efficiency and throughput of data processing compared to scalar processing. In other examples, the processor 2 may be a vector processor and the coprocessor 4 may be a matrix processor. In other examples, the processor 2 may be a vector processor and the coprocessor 4 may be a vector processor. These examples are not limiting and other arrangements or permutations of respective capabilities of the processor 2 and the coprocessor 4 may be provided.

It will be appreciated that the number of processors 2 and coprocessors 4 and arrangement thereof shown in FIG. 1 is just an example and may be varied depending on implementation. In other examples, a plurality of processors and/or a plurality of coprocessors may be provided. In such an example, arbitration circuitry may also be provided to control access to the coprocessors.

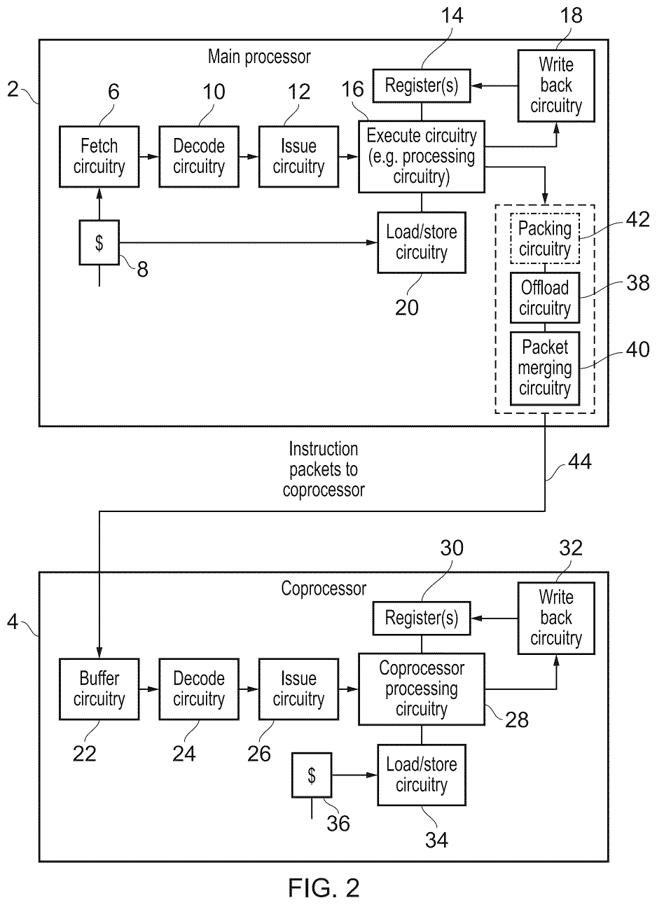

FIG. 2 shows an example arrangement of a main processor and a coprocessor to process instruction packets offloaded by the main processor.

In this example, main processor 2 corresponds to processor 2 of FIG. 1, and coprocessor 4 corresponds to coprocessor 4 of FIG. 1.

Main processor 2 has a processing pipeline which includes a number of pipeline stages. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in registers 14 and issuing micro-operations for execution once the required operands for a given micro-operation are available; an execute stage 16 (an example of processing circuitry) for executing data processing operations corresponding to the micro-operations, by processing operands read from the registers 14 to generate result values; and a writeback stage 18 for writing the results of the processing back to the registers 14. It will be appreciated that this is merely one example of possible pipeline arrangement, and other systems may have additional stages or a different configuration of stages. For example, in an out-of-order processor a register renaming stage could be included for mapping architectural registers specified by program instructions or micro-operations to physical register specifiers identifying physical registers in the registers 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 can include a number of processing units (not shown), for executing different classes of processing operation. For example, the execution units may include a scalar processing unit (e.g. comprising a scalar arithmetic/logic unit (ALU) for performing arithmetic or logical operations on scalar operands read from the registers 14); and a vector processing unit for performing vector operations on vectors comprising multiple vector elements. Load/store circuitry 20 is included for performing load/store operations to access data in a memory system (not shown, but which may include cache 8). Other examples of processing units which could be provided at the execute stage could include a floating-point unit for performing operations involving values represented in floating-point format, or a branch unit for processing branch instructions.

Register 14 may include a plurality of registers, such as scalar registers for storing scalar values, vector registers for storing vector values, and predicate registers for storing predicate values. The predicate values may be used by the vector processing unit when processing vector instructions, with a predicate value in a given predicate register indicating which vector elements of a corresponding vector operand stored in the vector registers are active (non-masked) vector elements or inactive (masked) vector elements (where operations corresponding to inactive data elements may be suppressed or may not affect a result value generated by the vector processing unit in response to a vector instruction).

While only cache 8 is shown, it will be appreciated that a memory hierarchy may be present which may include a plurality of different level caches and a main system memory. The memory system is not particularly limited in this respect.

The coprocessor 4 can include similar circuitry and components to the main processor 2, as shown in FIG. 2. In other examples, the circuitry may be different and this may vary depending on implementation. The coprocessor 4 in this example may be provided to execute instructions offloaded by the main processor via the communication channel 44 (such as vector operations or a subset of vector operations).

The coprocessor 4 may comprise buffer circuitry 22 for buffering instructions received from the main processor 2, decode circuitry 24 for decoding the buffered instructions, and coprocessor issue circuitry 26 for receiving the decoded microoperations from the coprocessor decode circuitry 24 and determining when operands for those instructions will be available and issuing the micro-operations to coprocessor processing circuitry 28 when the operands are available. The coprocessor 4 may signal to the main processor 2 that the co-processor is likely to stall/has stalled when an occupancy of the buffer circuitry 22 is greater than a predetermined threshold (so-called co-processor backpressure). The coprocessor 4 may have its own registers 30 separate from register 14 and the main processor 2. The coprocessor 4 may have access to the shared memory system shared with the main processor 2 and so can execute vector load/store instructions to load/store data from/to memory (for example, the coprocessor 4 may have access to one or more of the main processor's data caches and may access main memory). The coprocessor processing circuitry 28 executes the load/store and computation operations represented by the instructions offloaded to the coprocessor 4 by the main processor 2, with reference to operands stored in the coprocessor register 30 and data accessed from the memory system. Coprocessor 4 also includes write back circuitry 32, load/store circuitry 34, and cache 36 which provide similar functionality to that discussed above for the main processor 2.

In the example of FIG. 2, the coprocessor 4 could be either on the same chip (integrated circuit) as the main processor 2, or on a separate chip. For example, the main processor 2 and coprocessor 4 may be implemented as separate chiplets on an interposer, each chiplet being manufactured as a separate component and then assembled on the interposer.

As shown in FIG. 2, main processor 2 also includes offload circuitry 38 to transmit to the coprocessor 4 an instruction packet comprising one or more instructions offloaded by processing circuitry (e.g. execute circuitry 16) for execution by the coprocessor 4. Main processor 2 also includes packet merge circuitry 40 to perform a packet merge as discussed herein. Main processor 2 may also include packing circuitry 42 to receive the one or more instructions offloaded by the processing circuitry (e.g. execute circuitry 16) and pack the one or more instructions into the instruction packet. In some examples, the packing circuitry 42 creates the instruction packet by packing one or more instructions (received at the processing circuitry in the same processing cycle) into the instruction packet. The packet merging circuitry 40 may then perform the packet merge on the instruction packet to include one or more additional instructions in the instruction packet (received at the processing circuitry in a later processing cycle than the one or more instructions) depending on whether the instruction packet has capacity (e.g. empty slots) to include one or more additional instructions. The offload circuitry 38 may then offload the instruction packet (having had one or more additional instructions included) to the coprocessor 4 for execution by the coprocessor 4 via the communication channel 44. In some cases as discussed herein, the packet merging circuitry 40 may perform the packet merge after the offload circuitry 38 has offloaded the instruction packet. That is to say, the packet merge may be performed before or after offloading the instruction packet.

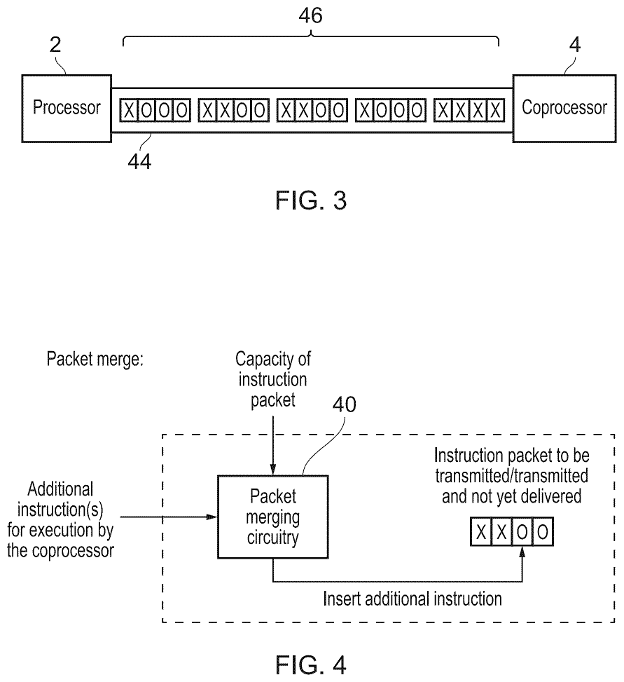

FIG. 3 shows an example communication channel 44 between a processor 2 and a coprocessor 4, such as the main processor 2 and coprocessor 4 of FIG. 2.

In this example, communication channel 44 includes a plurality of instruction packets 46. Each instruction packet comprises a plurality of slots, which are either filled with an instruction (shown by ‘x’) or are empty (shown by ‘o’). In this example, each instruction packet has a maximum capacity of four instructions (i.e. four slots) but it will be appreciated that this is only an example and the number may vary depending on implementation. The plurality of instructions packets 46 have been transmitted from the processor 2 to the communication channel 46. The plurality of instruction packets 46 may then be processed in the order in which they are received at the coprocessor 4.

The packet merge described herein may be performed on an instruction packet that has been delayed and not yet transmitted to the communication channel 44 (and this is not shown in FIG. 3), or it may be performed on an instruction packet of the plurality of packets 46 that has already been transmitted to the communication channel 44. In some examples, the packet merge is performed on the instruction packet that has most recently been transmitted to the communication channel (i.e. the left-most instruction packet of the plurality of instruction packets 46). It will be appreciated that the present technique is not particularly limited in this respect.

FIG. 4 shows an example packet merge according to the present technique. Packet merging circuitry 40 (e.g. packet merging circuitry 40 of FIG. 2) determines whether an instruction packet has capacity to include one or more additional instructions. Packet merging circuitry 40 may also receive one or more additional instructions for execution by a coprocessor. Packet merging circuitry 40 then includes the one or more additional instructions in the instruction packet in response to determining that the instruction packet has capacity to include the one or more additional instructions. As shown in FIG. 4, the instruction packet has four slots, two of which include an instruction and two of which are empty. The packet merging circuitry 40 in this example therefore determines that the instruction packet has capacity to include up to two additional instructions. In this example, an additional instruction is received by the packet merging circuitry 40 and so the packet merging circuity 40 includes the additional instruction in an empty slot of the instruction packet. As shown in FIG. 4, the instruction packet is an instruction packet that is to be transmitted to the communication channel to the coprocessor, or is an instruction packet that has been transmitted to the communication channel but has not yet been received by the coprocessor (i.e. it is queued in the communication channel 44), as described above with reference to FIG. 3.

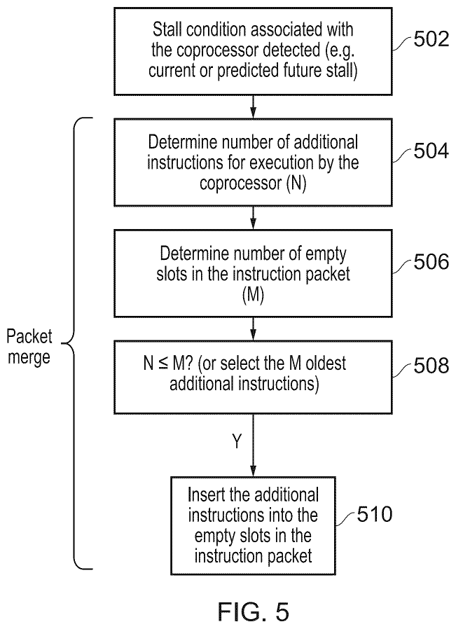

FIG. 5 shows steps for performing a packet merge in response to a stall condition. At step 502, a stall condition associated with the coprocessor is detected. This may be indicative of a current stall that the coprocessor is currently experiencing, or a predicted future stall that the coprocessor is predicted to experience in the future. For example, the coprocessor may signal that it is experiencing a stall, or packet merging circuitry may detect the predicted future stall condition based on information associated with the instructions being offloaded (for example that the instructions being offloaded are memory access load requests that may result in a cache miss at the coprocessor).

At step 504, the number of additional instructions for execution by the coprocessor (N) is determined. This may comprise determining the number of additional instructions based on the number of additional instructions received at the processing circuitry at a later processing cycle than instructions already included in an instruction packet (which has already been created and is either waiting for transmission or has already been transmitted to the communication channel to the coprocessor). For example, the number of additional instructions may correspond to the number of instructions received at a following processing cycle from the processing cycle associated with the instructions already included in the instruction packet.

At step 506, the number of empty slots in the instruction packet (M) is determined. At step 508, it is determined whether the number of additional instructions is less than or equal to the number of empty slots in the instruction packet (or the M oldest additional instructions are selected in some implementations where the number of additional instructions is greater than the number of empty slots). When it is determined that the number of additional instructions is less than or equal to the number of empty slots in the instruction packet, the process continues to step 510, where the additional instructions are inserted into the empty slots in the instruction packet. When it is determined that the number of additional instructions is greater than the number of empty slots in the instruction packet, the M oldest additional instructions may be inserted into the instruction packet at step 510.

In this way, instructions offloaded from processing circuitry at different processing cycles can be included in the same instruction packet to increase the utilization of the instruction packet. Further, the packet merge is performed in response to a stall condition, so as to provide increased utilization of the communication channel between the processor and coprocessor when the coprocessor is not able or unlikely to be able to operate at maximum throughput. This can increase processing performance and prevent bubbles and stalling of the processing circuitry (i.e. the main processor) as discussed above.

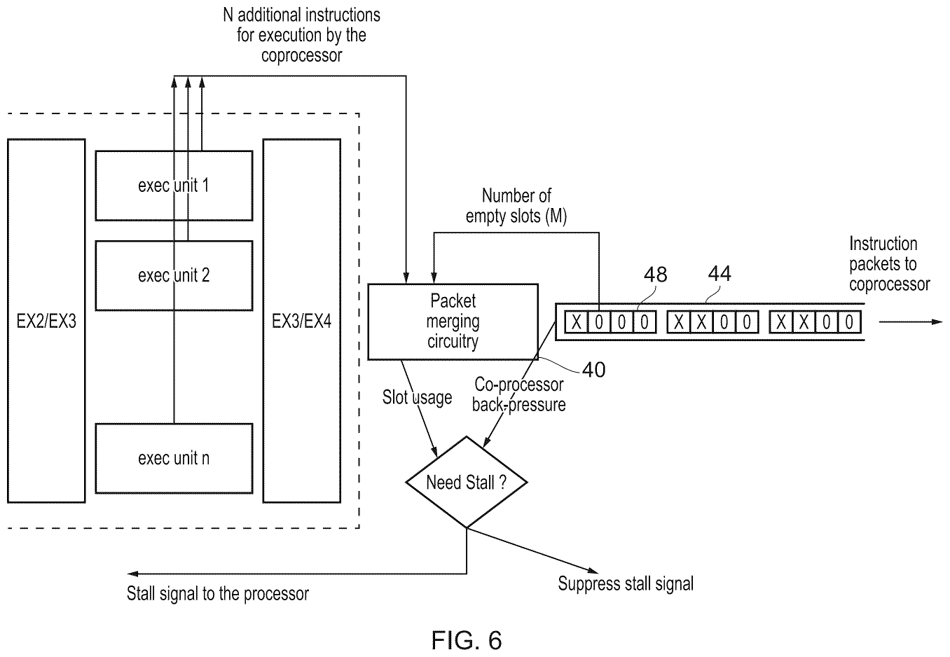

FIG. 6 shows an example arrangement for performing a packet merge. Communication channel 44 includes a plurality of instruction packets, including instruction packet 48. In this example, instruction packet 48 is the instruction packet most recently transmitted to the communication channel 44, but it will be appreciated that this technique may be used for instruction packets further along the communication channel to the coprocessor (or indeed one that has not yet been transmitted to the communication channel 44). In this example, instruction packet 48 includes one instruction and three empty slots each able to receive an additional instruction. Packet merging circuitry 40 determines the capacity of instruction packet 48 (e.g. it determines the number of empty slots M).

Packet merging circuitry 40 also determines the number of additional instructions for execution by the coprocessor that are offloaded from one or more execution units (exec unit 1 to n in this example) for execution by the coprocessor. These additional instructions are offloaded by the execution units/received at the execution units in a later processing cycle than the instruction already included in instruction packet 48. The instructions for execution by the coprocessor may be offloaded from specific execution units. In other examples, the instructions may be offloaded from a decode stage rather than an execute stage, depending on implementation.

The packet merging circuitry 40 performs a packet merge to include the N additional instructions in the instruction packet 48 in accordance with the method of FIG. 5. In this case, the packet merging circuitry 40 detects coprocessor back pressure (i.e. that the communication channel 44 is full and/or that the coprocessor has signaled a stall) and determines whether to signal the main processor to also stall. When the packet merging circuitry 40 is able to perform the packet merge, the packet merging circuitry 40 may suppress the stall signal for the main processor (because an instruction for the coprocessor that could not be offloaded and would have caused the processing circuitry to stall can instead be included in an existing instruction packet). When the packet merging circuitry 40 is unable to perform the packet merge, the processor may be signaled to stall.

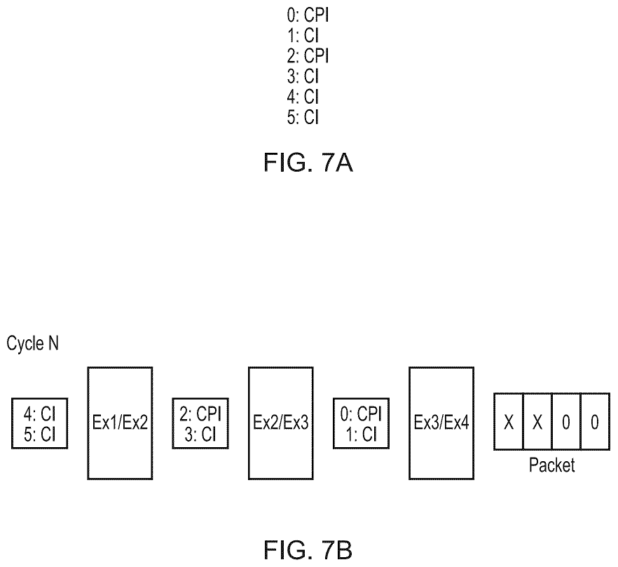

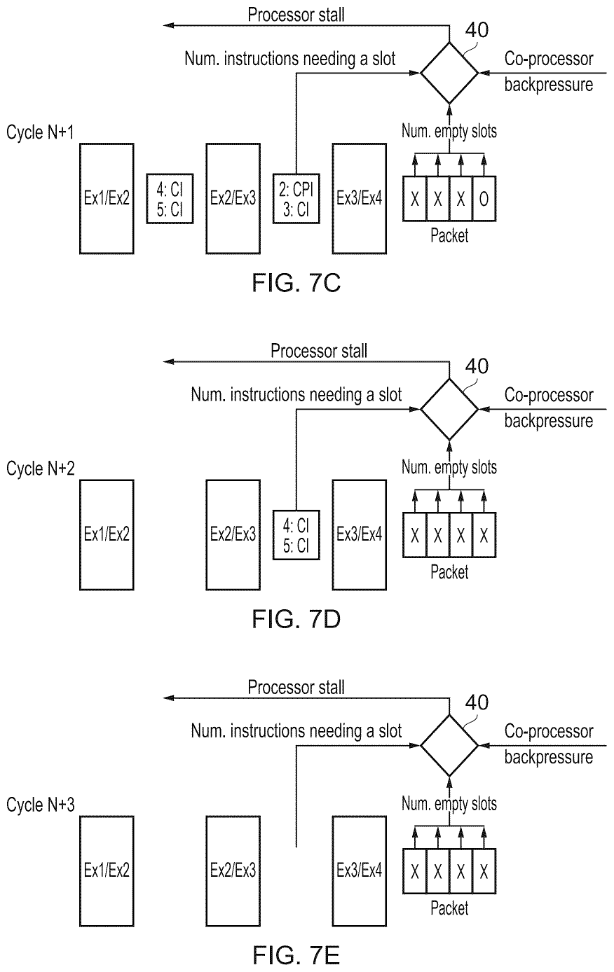

In this way, the packet merge can prevent the stalling of the processor when the coprocessor stalls. Hence, processor performance is increased. The way in which the packet merge can avoid the processing circuitry from stalling will be described in further detail with reference to FIGS. 7A to 7E. These examples show a 2-wide core.

FIG. 7A shows an example instruction sequence. Instructions that are to be executed by the main processor are denoted ‘CI’ and instructions that are to be offloaded to the coprocessor for execution by the coprocessor are denoted ‘CPI’. Without the packet merge according to the present techniques, when the coprocessor stalls, the instruction sequence will be stalled when a CPI instruction is next to be offloaded at the main processor until the coprocessor is no longer stalling. With the packet merge, the two CPI instructions (i.e. coprocessor instructions) can be merged into one or more existing instruction packets to prevent the main processor from stalling, thereby reducing processing bubbles at the main processor.

FIG. 7B shows an example pipeline for processing the instruction sequence at cycle N. As shown, an existing instruction packet is present in the communication channel that includes two instructions and two empty slots. The execute stages of the pipeline (Ex1-Ex4) all have instructions from the instruction sequence in flight. As the communication channel to the coprocessor is full (as a result of the coprocessing stall), the instruction packet will not be delivered to the coprocessor and will instead sit in the communication channel. At cycle N, because instruction 0 is a CPI instruction, without packet merging, the main processor will be stalled as a result of the coprocessor having stalled. Indeed, the main processor will stall until the coprocessing exits its stall and instruction 0: CPI can successfully be offloaded. However, the instruction packet has two empty slots.

FIG. 7C shows the example pipeline at cycle N+1. The packet merging circuitry 40 checks the number of empty slots of the instruction packet, and determines how many additional instructions are to be included. In this case, instruction 0: CPI was to be included, and so the packet merging circuitry 40 has included instruction 0: CPI in the instruction packet, using an empty slot, because the instruction packet had capacity. The instruction packet now includes three instructions (the instructions already present at cycle N, and an additional instruction from N+1) and one empty slot. As instruction 0: CPI could be included in the instruction packet, the coprocessor stall signal can be ignored, and the main processor is not also stalled. In this case, a stall signal for the main processor is suppressed or not generated. The instructions are moved through the execute stages of the pipeline and instructions 0 and 1 have retired (instruction 1: CI having been executed during this cycle).

FIG. 7D shows the example pipeline at cycle N+2. The packet merge has been repeated, and instruction 2: CPI which was at the final execute stage at cycle N+1, has been included in the instruction packet. The instruction packet now includes four instructions (the instructions already present at cycle N, the additional instruction from cycle N+1—0: CPI, and an additional instruction from cycle N+2—2: CPI). The instructions are moved through the execute stages of the pipeline and instructions 2 and 3 have retired (instruction 3: CI having been executed during this cycle).

FIG. 7E shows the example pipeline at cycle N+3. The final instructions (instructions 3: CI and 4: CI of cycle N+2) do not require slots in the instruction packet as they are not CPI instructions, and so these are executed in the main processor and are retired.

As a result of the packet merge, stalling of the main processor was prevented, thereby avoiding processing bubbles and increasing processing performance.

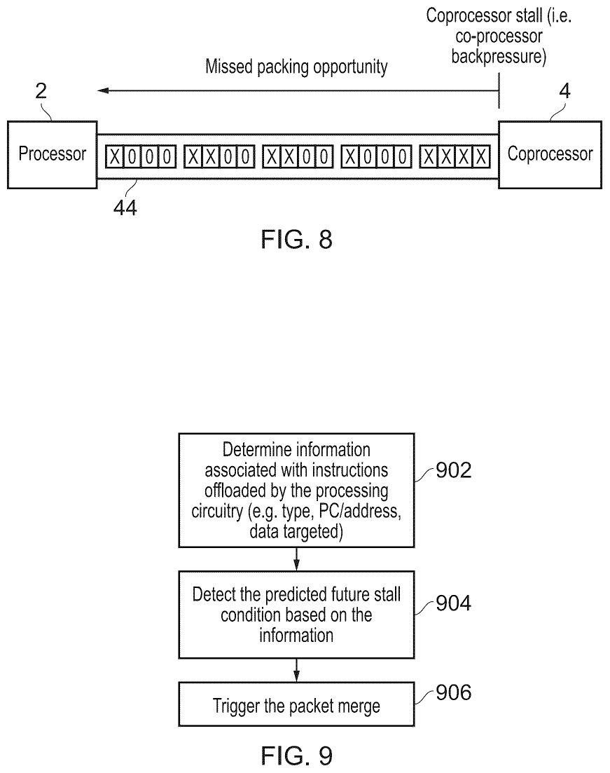

As discussed above, the packet merge may be performed in response to detecting a stall condition indicative of a current stall of the coprocessor. For example, when the coprocessor signals a current stall or backpressure to the main processor. However, in some examples, it can be useful to perform the packet merge in advance of receiving a signal indicative of a current coprocessor stall. This is shown with reference to FIG. 8.

FIG. 8 shows an example of a missed packet merge opportunity, and shows a similar arrangement to that of FIG. 3. Because it can take a number of processing cycles for the coprocessor to detect and signal a stall, and for the main processor to receive the signal indicative of the stall, a number of packet merging opportunities may be missed.

As shown in FIG. 8, the communication channel 44 includes five instruction packets that have already been transmitted to the communication channel 44 before the stall has been detected at the main processor and thus before the packet merging has been turned on in response. While the techniques discussed herein may insert additional instructions to the instruction packets in the communication channel 44, such as instruction packets further along the communication channel 44 than the most recently added instruction packet, doing so can increase circuity complexity and power demand. It can therefore be useful to start packet merging before a stall signal indicative of a current coprocessing stall is actually received by the main processor.

Hence, in some examples, detection of a predicted future stall condition is used to trigger the packet merge. This will now be discussed.

FIG. 9 shows steps for triggering a packet merge in response to detecting a predicted future stall condition.

At step 902, information associated with instructions offloaded by processing circuitry is determined. This information can include one or more of: an instruction type (e.g. memory access or non-memory access); program counter; address; and data targeted by the instruction. At step 904, the predicted future stall condition is detected based on the information. The present inventors have identified that the information as described above that is associated with a given instruction can be indicative of a likelihood that the given instruction will cause the coprocessing circuitry to stall when the coprocessing circuitry executes the given instruction in the future. As an example, a memory load instruction may have an increased likelihood of causing a coprocessor stall due to the possibility of a cache miss compared to a matrix multiplication. At step 904, the packet merge is triggered, in response to detecting the predicted future stall condition at step 902.

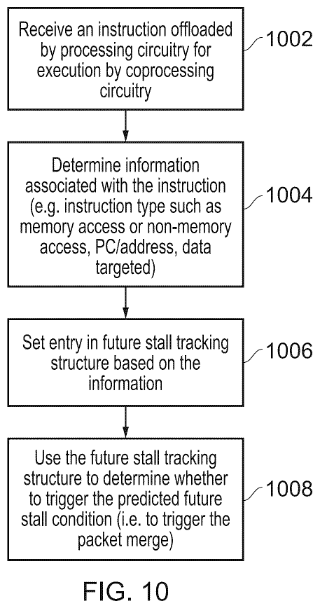

FIG. 10 shows steps for triggering a packet merge using a future stall tracking structure.

At step 1002, an instruction offloaded by processing circuitry for execution by coprocessing circuitry is received. At step 1004, information associated with the instruction (e.g. one or more of: instruction type; PC and/or address associated with the instruction; and data targeted by the instruction) is determined. At step 1006, an entry in the future stall tracking structure is set based on the determined information. At step 1008, the future stall tracking structure is used to determine whether to trigger detection of the predicted future stall condition (i.e. to trigger the packet merge).

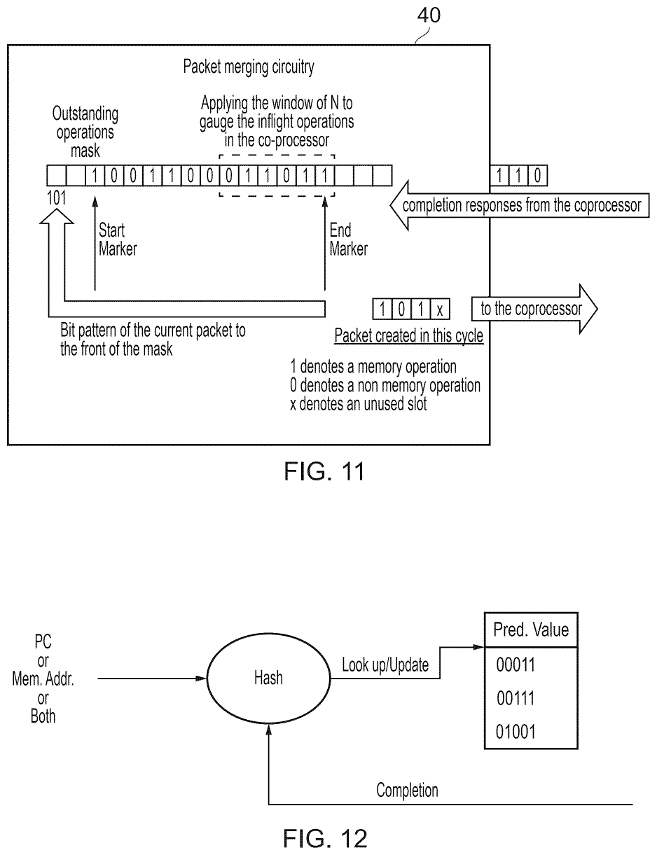

The future stall tracking structure can take various forms. An example of the future stall tracking structure is shown in FIG. 11.

In FIG. 11, a circular bit mask is used to track offloaded instructions that are transmitted to the communication channel/coprocessor. In this example, an instruction type is used to inform whether an instruction is likely to cause a stall, but it will be appreciated that other forms of information associated with an instruction may be used in addition or instead, as discussed above. For example, an amount of data a memory load is to load. Instructions offloaded to the coprocessor may be categorized into two instruction types: memory access (load/store) instructions and non-memory access instructions (e.g. matrix multiplications). Memory access instructions may be more likely to cause a coprocessor stall as the data may need to be loaded from next level caches/memories, while non-memory access instructions may be more likely to complete with no (or minimal) disruption/s.

A bit (e.g. entry) can be set in the future stall tracking structure to indicate a memory access operation, and a cleared bit indicates a non-memory access operation. Two markers are used to indicate the front and the back of the circular bit mask. Upon receiving completion response (say M) from the coprocessor, the back marker is moved M number positions, for the said instruction type (memory or non-memory). By looking at the bit pattern closer to the back marker, the ratio of inflight memory access operations vs non-memory access operations for a given window can be determined. If the inflight memory access operations have exceeded a predetermined threshold, this indicates that a coprocessor stall is likely. The stall in the coprocessor means that it will not be able to pick instruction packets from the communication channel and thus the communication channel is about to be blocked. Predicting when the communication channel is going to be blocked using the future stall tracking structure means that the transmitting of partially filled instruction packets can be avoided, and instead instruction packets can be delayed until the instruction packet is full.

Another example of the future stall tracking structure, and the updating of entries therein, is shown in FIG. 12.

In the example of FIG. 12, the future stall tracking structure is a table. The table is indexed using a hash of the program counter and/or address associated with the instruction offloaded to the coprocessing circuitry. Each entry of the table comprises a prediction indicator to indicate the likelihood that the instruction associated with the respective entry is likely to cause the coprocessor stall when executed. For example, each entry may comprise a one or more bit indicator which indicates the likelihood that the instruction associated with the respective index causes the coprocessor to stall when executed by the coprocessor. Upon receiving completion responses from the coprocessor, the entry is updated according to the success/failure of the prediction.

For example, if each entry comprises a two-bit value indicator, and 0 indicates a failed prediction and 1 indicates a successful prediction, the following transitions may be used: 00-(1)->01-(1)->10-(1)->11-(1)->11, 11-(0)->10-(0)->01-(0)->00-(0)->00.

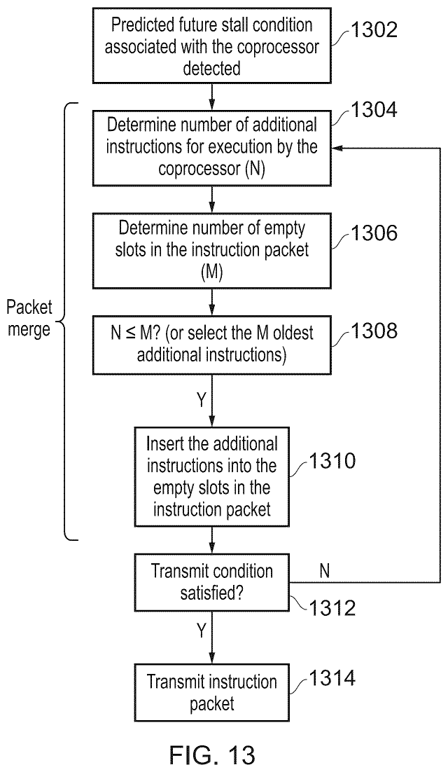

FIG. 13 shows steps for packet merging based on predicting a future stall associated with the coprocessor and transmitting an instruction packet based on satisfaction of a transmit condition.

At step 1302, a predicted future stall condition associated with the coprocessor is detected. For example, step 1302 may be detected as discussed above. Steps 1304 to 1310 correspond to steps 502 to 510 of FIG. 5. At step 1312, it is determined whether a transmit condition is satisfied. The transmit condition may include one or more of: determining that a predetermined amount of time has elapsed since an instruction packet transmission delay started; determining that the instruction packet has no capacity to include an additional instruction; and/or determining that a completion response has been received from the coprocessing circuitry indicating that an instruction likely to stall the coprocessing circuitry has been completed. If the transmit condition is not satisfied, the process returns to step 1304 and the packet merge is repeated. If the transmit condition is satisfied, the process continues to step 1314, where the instruction packet is transmitted to the communication channel. Operation may then return to normal where instruction packets are offloaded when they are ready so as to maximize throughput to the coprocessor, rather than being delayed to perform a packet merge, until it is determined that an instruction to be offloaded is likely to cause a coprocessing stall, where the packet merge may be performed again.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

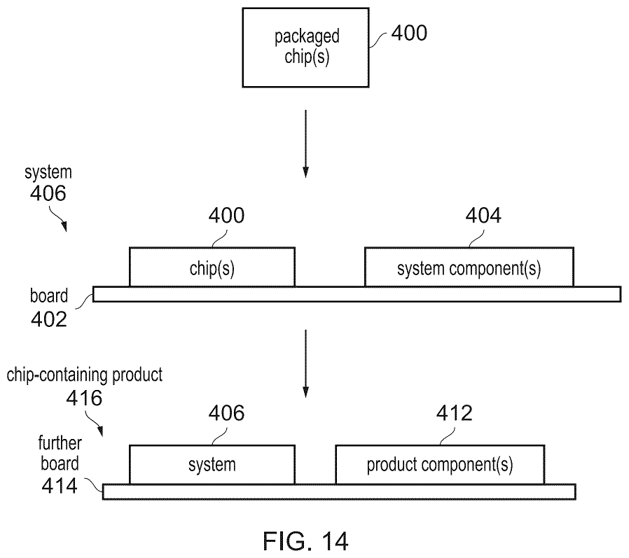

As shown in FIG. 14, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
1. An apparatus comprising:
   offload circuitry to transmit to coprocessing circuitry an instruction packet comprising one or more instructions offloaded by processing circuitry for execution by the coprocessing circuitry; and
   packet merging circuitry to perform a packet merge comprising:
   determining whether the instruction packet has capacity to include one or more additional instructions offloaded by the processing circuitry for execution by the coprocessing circuitry; and
   including the one or more additional instructions in the instruction packet in response to determining that the instruction packet has capacity to include the one or more additional instructions.
2. The apparatus of clause 1, in which the one or more additional instructions are associated with a later processing cycle of the processing circuitry than the one or more instructions.
3. The apparatus of any preceding clause, in which the packet merging circuitry is configured to perform the packet merge in response to detecting a stall condition associated with the coprocessing circuitry.
4. The apparatus of clause 3, in which the stall condition comprises one or more of a current stall condition indicative of a current stall associated with the coprocessing circuitry and a predicted future stall condition indicative of a predicted future stall associated with the coprocessing circuitry.
5. The apparatus of clause 4, in which to detect the current stall condition, the packet merging circuitry is configured to receive a signal indicating a loading of the coprocessing circuitry.
6. The apparatus of clause 5, in which the signal indicates that an occupancy of a buffer associated with the coprocessing circuitry for incoming instruction packets has exceeded a predetermined threshold.
7. The apparatus of any of clauses 4 to 6, in which to detect the predicted future stall condition, the packet merging circuitry is configured to determine that the coprocessing circuitry is likely to stall during future execution of one or more instructions offloaded by the processing circuitry.
8. The apparatus of clause 7, in which the packet merging circuitry is configured to determine that the coprocessing circuitry is likely to stall based on determining information associated with the one or more instructions offloaded by the processing circuitry, the information being indicative of a likelihood that the one or more instructions offloaded by the processing circuitry will stall the coprocessing circuitry during future execution of the one or more instructions.
9. The apparatus of clause 8, in which to determine the information, the packet merging circuitry is configured to determine one or more of: an instruction type of the one or more instructions; a program counter and/or memory address associated with the one or more instructions; and data targeted by the one or more instructions.
10. The apparatus of clause 9, in which the instruction type comprises a memory access instruction type and a non-memory access instruction type.
11. The apparatus of any of clauses 8 to 10, in which the packet merging circuitry is configured to determine that the coprocessing circuitry is likely to stall based on a future stall tracking structure, the future stall tracking structure to store entries determined based on the information and indicative of respective likelihoods that the one or more instructions offloaded by the processing circuitry will stall the coprocessing circuitry during future execution of the one or more instructions.
12. The apparatus of clause 11, in which the future stall tracking structure indicates a relative frequency of instructions in the one or more instructions offloaded by the processing circuitry having a given instruction type, and the packet merging circuitry is configured to determine that the coprocessing circuitry is likely to stall based on determining that the relative frequency exceeds a predetermined threshold.
13. The apparatus of clause 11, in which the future stall tracking structure comprises a table indexed based on program counter values and/or memory addresses associated with the one or more instructions offloaded by the processing circuitry, and the packet merging circuitry is configured to determine that the coprocessing circuity is likely to stall based on determining that an entry in the table corresponding to a program counter and/or memory address associated with a given instruction offloaded by the processing circuitry indicates that the coprocessing circuitry is likely to stall during future execution of the given instruction.
14. The apparatus of any of clauses 11 to 13, in which the packet merging circuitry is configured to update the entries based on determining whether a given entry correctly predicted whether a given instruction offloaded by the processing circuitry stalled the coprocessing circuitry based on a completion response from the coprocessing circuitry.
15. The apparatus of any of clauses 3 to 14, in which in response to detecting the stall condition associated with the coprocessing circuitry, the packet merging circuitry is configured to repeat the packet merge for one or more subsequent processing cycles and delay transmitting the instruction packet to the coprocessing circuitry packet until a transmit condition is satisfied.
16. The apparatus of clause 15, in which the transmit condition comprises one or more of: determining that a predetermined amount of time has elapsed since the delay started; determining that the instruction packet has no capacity to include an additional instruction; and/or determining that a completion response has been received from the coprocessing circuitry indicating that an instruction likely to stall the coprocessing circuitry has been completed.
17. The apparatus of any preceding clause, in which to transmit the instruction packet to the coprocessing circuitry, the offload circuitry is configured to transmit the instruction packet to a communication channel to the coprocessing circuitry, and the packet merging circuitry is configured to perform the packet merge after the offload circuitry has transmitted the instruction packet to the communication channel.
18. The apparatus of any preceding clause, in which determining whether the instruction packet has capacity to include one or more additional instructions comprises comparing a quantity of the one or more additional instructions to a quantity of empty instruction slots in the instruction packet for receiving instructions.
19. The apparatus of any preceding clause, further comprising packing circuitry to receive the one or more instructions offloaded by the processing circuitry and pack the one or more instructions into the instruction packet.
20. The apparatus of any preceding clause, in which the one or more instructions and the one or more additional instructions are from an instruction stream executed by the processing circuitry.
21. The apparatus of any preceding clause, further comprising the processing circuitry, the processing circuitry comprising a processing pipeline, and in which the one or more instructions and the one or more additional instructions are offloaded from one or more execution units of the processing pipeline for offloading instructions for execution by the coprocessing circuitry.
22. The apparatus of any preceding clause, in which the packet merging circuitry is configured to suppress a processing circuitry stall signal in response to including the one or more additional instructions in the instruction packet.
23. A system comprising the apparatus of any of clauses 1 to 22 and the coprocessing circuitry.
24. A system comprising:
an apparatus comprising:
offload circuitry to transmit to coprocessing circuitry an instruction packet comprising one or more instructions offloaded by processing circuitry for execution by the coprocessing circuitry; and
packet merging circuitry to perform a packet merge comprising:
   determining whether the instruction packet has capacity to include one or more additional instructions offloaded by the processing circuitry for execution by the coprocessing circuitry; and
   including the one or more additional instructions in the instruction packet in response to determining that the instruction packet has capacity to include the one or more additional instructions, implemented in at least one packaged chip;
      at least one system component; and
   a board,
wherein the at least one packaged chip and the at least one system component are assembled on the board.
25. A chip-containing product comprising the system of clause 24, wherein the system is assembled on a further board with at least one other product component.
26. A non-transitory computer-readable medium storing computer-readable code for fabrication of an apparatus according to any of clauses 1 to 22.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
offload circuitry to transmit to coprocessing circuitry an instruction packet comprising one or more instructions offloaded by processing circuitry for execution by the coprocessing circuitry; and
packet merging circuitry to perform a packet merge comprising:
determining whether the instruction packet has capacity to include one or more additional instructions offloaded by the processing circuitry for execution by the coprocessing circuitry; and
including the one or more additional instructions in the instruction packet in response to determining that the instruction packet has capacity to include the one or more additional instructions.

2. The apparatus of claim 1, in which the one or more additional instructions are associated with a later processing cycle of the processing circuitry than the one or more instructions.

3. The apparatus of claim 1, in which the packet merging circuitry is configured to perform the packet merge in response to detecting a stall condition associated with the coprocessing circuitry.

4. The apparatus of claim 3, in which the stall condition comprises one or more of a current stall condition indicative of a current stall associated with the coprocessing circuitry and a predicted future stall condition indicative of a predicted future stall associated with the coprocessing circuitry.

5. The apparatus of claim 4, in which to detect the current stall condition, the packet merging circuitry is configured to receive a signal indicating a loading of the coprocessing circuitry.

6. The apparatus of claim 4, in which to detect the predicted future stall condition, the packet merging circuitry is configured to determine that the coprocessing circuitry is likely to stall during future execution of one or more instructions offloaded by the processing circuitry.

7. The apparatus of claim 6, in which the packet merging circuitry is configured to determine that the coprocessing circuitry is likely to stall based on determining information associated with the one or more instructions offloaded by the processing circuitry, the information being indicative of a likelihood that the one or more instructions offloaded by the processing circuitry will stall the coprocessing circuitry during future execution of the one or more instructions.

8. The apparatus of claim 7, in which to determine the information, the packet merging circuitry is configured to determine one or more of: an instruction type of the one or more instructions; a program counter and/or memory address associated with the one or more instructions; and data targeted by the one or more instructions.

9. The apparatus of claim 7, the packet merging circuitry is configured to determine that the coprocessing circuitry is likely to stall based on a future stall tracking structure, the future stall tracking structure to store entries determined based on the information and indicative of respective likelihoods that the one or more instructions offloaded by the processing circuitry will stall the coprocessing circuitry during future execution of the one or more instructions.

10. The apparatus of claim 9, in which the future stall tracking structure indicates a relative frequency of instructions in the one or more instructions offloaded by the processing circuitry having a given instruction type, and the packet merging circuitry is configured to determine that the coprocessing circuitry is likely to stall based on determining that the relative frequency exceeds a predetermined threshold.

11. The apparatus of claim 9, in which the future stall tracking structure comprises a table indexed based on program counter values and/or memory addresses associated with the one or more instructions offloaded by the processing circuitry, and the packet merging circuitry is configured to determine that the coprocessing circuity is likely to stall based on determining that an entry in the table corresponding to a program counter and/or memory address associated with a given instruction offloaded by the processing circuitry indicates that the coprocessing circuitry is likely to stall during future execution of the given instruction.

12. The apparatus of claim 9, in which the packet merging circuitry is configured to update the entries based on determining whether a given entry correctly predicted whether a given instruction offloaded by the processing circuitry stalled the coprocessing circuitry based on a completion response from the coprocessing circuitry.

13. The apparatus of claim 3, in which in response to detecting the stall condition associated with the coprocessing circuitry, the packet merging circuitry is configured to repeat the packet merge for one or more subsequent processing cycles and delay transmitting the instruction packet to the coprocessing circuitry packet until a transmit condition is satisfied.

14. The apparatus of claim 13, in which the transmit condition comprises one or more of: determining that a predetermined amount of time has elapsed since the delay started; determining that the instruction packet has no capacity to include an additional instruction; and determining that a completion response has been received from the coprocessing circuitry indicating that an instruction likely to stall the coprocessing circuitry has been completed.

15. The apparatus of claim 1, in which to transmit the instruction packet to the coprocessing circuitry, the offload circuitry is configured to transmit the instruction packet to a communication channel to the coprocessing circuitry, and the packet merging circuitry is configured to perform the packet merge after the offload circuitry has transmitted the instruction packet to the communication channel.

16. The apparatus of claim 1, in which the packet merging circuitry is configured to suppress a processing circuitry stall signal in response to including the one or more additional instructions in the instruction packet.

17. A system comprising the apparatus of claim 1 and the coprocessing circuitry.

18. A system comprising:
an apparatus comprising:
offload circuitry to transmit to coprocessing circuitry an instruction packet comprising one or more instructions offloaded by processing circuitry for execution by the coprocessing circuitry; and
packet merging circuitry to perform a packet merge comprising:
determining whether the instruction packet has capacity to include one or more additional instructions offloaded by the processing circuitry for execution by the coprocessing circuitry; and
including the one or more additional instructions in the instruction packet in response to determining that the instruction packet has capacity to include the one or more additional instructions, implemented in at least one packaged chip;
at least one system component; and
a board,
wherein the at least one packaged chip and the at least one system component are assembled on the board.

19. A chip-containing product comprising the system of claim 18, wherein the system is assembled on a further board with at least one other product component.

20. A non-transitory computer-readable medium storing computer-readable code for fabrication of an apparatus according to claim 1.
